(19) United States
(12) Patent Application Publication
(10) Pub. No.: US 2010/0025901 A1
(43) Pub. Date: Feb. 4, 2010

(54) Damping Drive Unit Mount

(75) Inventors: Manfred Hofmann, Hunfelden (DE); Arndt Graeve, Koblenz (DE)

Correspondence Address: LERNER GREENBERG STEMER LLP, P O BOX 2480, HOLLYWOOD, FL, 33022-2480, US

(73) Assignee: TRELLEBORG AUTOMOTIVE TECHNICAL CENTRE GMBH, Höhr-Grenzhausen (DE)

(21) Appl. No.: 12/376,229

(22) PCT Filed: Aug. 1, 2007
(86) PCT No.: PCT/EP2007/057985

§ 371 Date: May 15, 2009

(30) Foreign Application Priority Data
Aug. 3, 2006 (DE) 10 2006 036 343.4

(51) Int. Cl. F16F 13/08; F16F 13/12; F16F 13/04

(52) U.S. Cl. 267/121; 267/140.11

(57) ABSTRACT

An attenuating unit bearing, particularly an engine mount for a motor vehicle has a support spring, which limits a working chamber filled with a working medium. In order to achieve a high temperature resistance at a low rate initial load, the support spring is made of a fiber composite. The matrix material of the fiber composite is a thermoplastic synthetic fiber having a high thermal stability, which can be made ready to process by deep drawing.

The present invention relates to a damping drive unit mount, in particular an engine mount for a motor vehicle, comprising a bearing spring, which defines a working chamber filled with a working medium.

Such drive unit mounts are used to connect the engine and the gearbox of a motor vehicle with the body. Such mounts must isolate the arising weight forces, moments and mass forces of the drive unit on the one hand, and on the other hand arising noise and vibrations.

To be able to fulfill this task, such drive unit mounts are formed as hydraulically or pneumatically damping mounts. They comprise a bearing spring surrounding a working chamber filled with a working medium. Such a well-known drive unit mount is described in DE 102 45 122 A1. The working chamber defined by the bearing spring communicates with the environment or a balancing chamber via a nozzle channel. The bearing spring is of an elastic, curable material. The natural rubber (NR) usually used for this purpose has a relatively low continuous heat resistance of about 80° C. Synthetic rubber (EPDM) has a continuous heat resistance of up to about 120° C. Applying continuous heat above 100° C. or 140° C., respectively, to these materials leads to their destruction.

Higher temperature resistance is required for the high-performance engines used in motor vehicles today, in particular in combination with engines encapsulated for noise insulation.

From EP 1 450 068 A2, it is known to provide a bearing spring of silicone rubber for a hydraulically damping mount. Heat resistance of up to 200° C. is thus allegedly achieved. In order to achieve sufficient resistance against the damping liquid, the inner wall of the bearing spring is provided with a protective layer of EPDM. Such bearing springs of silicone rubber only have poor strength, however. Furthermore, their tear resistance is low, so that tears propagate quickly.

DE 41 06 838 A1 describes a damping drive unit mount, which has an annular spring body of composite fiber material. The spring body consists of a plurality of layers of fibers impregnated with synthetic resin, which are circumferentially wound primarily transverse to the direction of stress. Glass fibers but also carbon fibers are essentially used as reinforcing fibers. Essentially thermosets, or even thermoplastics, for example polyetheretherketone, are used as curable matrix materials. The annular spring body surrounds a hydraulic damping means, comprising a working chamber enclosed by a bellows. The working chamber communicates with a balancing chamber via a damping channel. Both chambers are filled with a hydraulic liquid. Such a drive unit mount has limited heat resistance due to the bellows consisting of an elastomeric material.

It is therefore the object of the present invention to suggest a drive unit mount having high heat resistance while settling only slightly under the initial load.

To solve this object it is suggested for a drive unit mount of the initially mentioned type that the bearing spring consist of a composite fiber material and that the matrix material of the composite fiber material is a thermoplastic material having high thermal stability, which can be processed by means of deep drawing.

In the drive unit mount according to the present invention the working chamber is defined by the bearing spring, which at the same time also receives the arising static loads. Since a thermoplastic material of high thermal stability is used, the drive unit mount according to the present invention is characterized by high heat resistance. Furthermore, it only settles slightly under the initial load, which means that the linear free stroke is not substantially reduced during the useful life. Further, the matrix material has the effect that only slight dynamic hardening occurs. The bearing spring produced by deep drawing can have any suitable geometric shape. In particular, the bearing spring can be formed in a rotation-symmetrical or rectangular shape. The drive unit mount according to the present invention has high vibration resistance and low weight and can also be cheaply manufactured.

Advantageous embodiments are the subject matter of the dependent claims.

In an advantageous embodiment, polyphenylene sulfide (PPS) is used as a matrix material. This material has high heat-shape resistance, low creeping tendencies and high bending strength. Polyphenylene sulfide also has very high hydrolysis resistance.

In an advantageous embodiment, it is suggested to use glass fibers, carbon fibers or aramide fibers as reinforcing fibers.

Advantageously, the bearing spring includes a layered structure of fibers as a fabric and/or a unidirectional fiber layer.

Advantageously, the layered structure is formed as a single layer or as a multi-layer structure.

To achieve sufficient flexibility, advantageously, a corrugated contour is formed in the bearing spring.

The bearing spring is advantageously fixed in a bottom or intermediate plate. The bottom plate can also be present as a structural part of the vehicle body. Advantageously, a mounting bolt is fixed on the bearing spring. Herein, the mounting bolt is advantageously cast into the matrix material of the bearing spring.

In an advantageous embodiment, the drive unit mount is formed as a pneumatically damping mount, wherein the working chamber is filled with a gas, in particular air. Due to the use of air as a damping medium, also high heat resistance of ≧130° C. and temperature independence of up to −30° C. is achieved. Further, such a drive unit mount only causes low costs as compared to hydraulically damping mounts.

Advantageously, the working chamber communicates with the environment or with a balancing chamber via a nozzle channel.

To reduce the space for the working chamber, it is provided in an advantageous embodiment that an inner wall of the bearing spring is provided with a layer reducing the volume of the working chamber.

In an advantageous further development, the layer is of a closed-pore foamed plastic material having high heat resistance.

In a further advantageous embodiment, the drive unit mount is formed as a hydraulically damping mount, wherein the working chamber is filled with a hydraulic liquid.

Herein, the working chamber communicates with a balancing chamber via a damping channel.

The working chamber is defined by a balancing membrane of an elastic material.

Since the bearing spring of composite fiber material has relatively high volume stiffness, advantageously, a decoupling means for decoupling small amplitudes is provided.

The decoupling means can be formed in an advantageous embodiment as a compressible material layer applied to the inner wall of the bearing spring.

The invention will be explained in the following with reference to exemplary embodiments, schematically shown in the drawings, wherein:

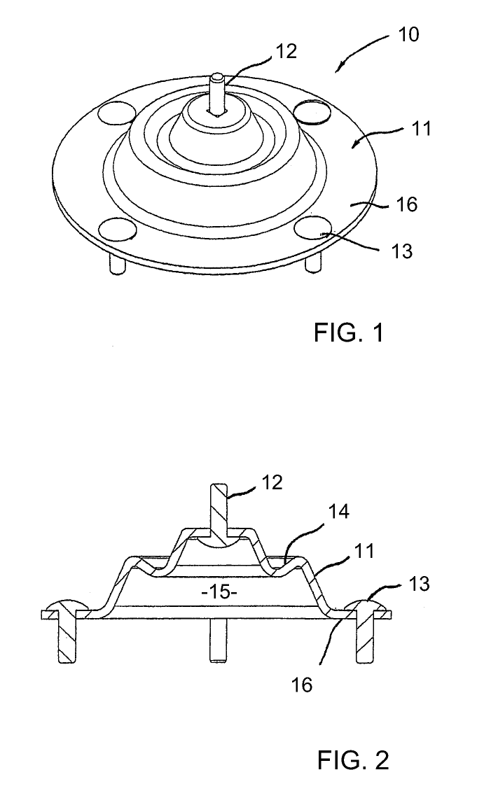

FIG. 1 is a perspective view of a first embodiment of a drive unit mount according to the present invention, which is formed as a pneumatically damping mount,

FIG. 2 is a vertical section through FIG. 1,

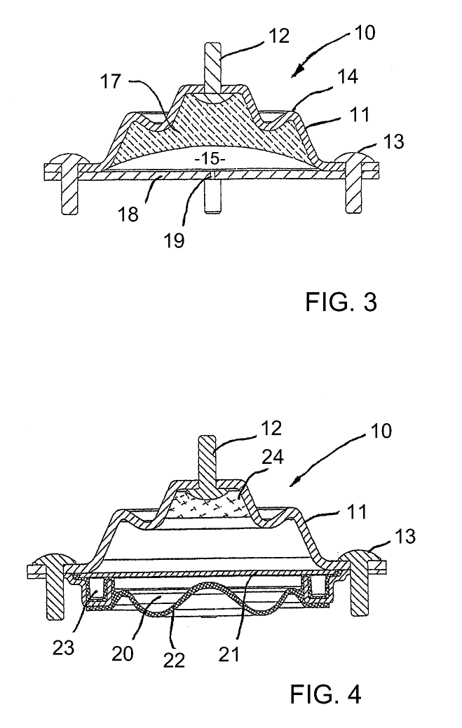

FIG. 3 is a vertical section through a second embodiment of a drive unit mount according to the present invention, and

FIG. 4 is a vertical section through a third embodiment of a drive unit mount according to the present invention.

Drive unit mount 10 shown in FIGS. 1 and 2 is formed as a pneumatically damping mount, which is used as an engine mount. Drive unit mount 10 has a working chamber 15, which is defined by a bearing spring 11. Bearing spring 11 is of a composite fiber material, wherein the matrix material of the composite fiber material is a thermoplastic material having high heat resistance. In the present case, the matrix material is polyphenylene sulfide (PPS). This material has a high heat deflection temperature (depending on each type, between 130° C. and 240° C.), low creeping tendencies and high bending strength. Furthermore, it has excellent hydrolysis resistance.

The composite fiber material has a layered structure of fibers, wherein, in the present case, a single layer of a fabric of glass fibers is provided. As an alternative, however, composite layers with a plurality of stacked individual layers can be provided.

Rotation-symmetrical bearing spring 11, having a bell shape, is obtained by deep drawing, wherein corrugated structure 14 is formed during deep drawing. Bearing spring 11 has high flexibility as a result of corrugated structure 14.

In the center of rotation-symmetrical bearing spring 11, a mounting bolt 12 is fixed, which is cast into the matrix material of bearing spring 11. With the help of mounting bolt 12 drive unit mount 10 is fixed to an engine (not shown) of a motor vehicle.

At edge 16 of bearing spring 11, a plurality of mounting bolts 13 is provided in a circumferentially spaced manner, which serves for fixing drive unit mount 10 on the vehicle body.

Drive unit mount 10 has high heat resistance, which is achieved on the one hand by the heat resistance of the bearing spring and on the other hand by the damping medium used (air).

The further exemplary embodiment shown in FIG. 3 of a drive unit mount 10 according to the present invention, for the description of which the reference numerals already used are used for the same or equivalent parts, has a coating 17 provided on the inner wall of bearing spring 11, which is of a closed-pore foamed plastic material having high heat resistance. EPDM can be used for this purpose, for example. A significant reduction of the volume of working chamber 15 is achieved by coating 17.

Bearing spring 11 is supported on a bottom plate 18, in the center of which a nozzle channel 19 is formed.

The further exemplary embodiment of a drive unit mount 10 according to the present invention as shown in FIG. 4 is formed as a hydraulically damping mount. Bearing spring 11 herein surrounds a working chamber 15 filled with a hydraulic liquid. Working chamber 15 is separated from a balancing chamber 20 by means of an intermediate plate 21. Balancing chamber 20 is defined by an elastic balancing membrane 22. Working chamber 15 is in hydraulic communication with balancing chamber 20 via a damping channel 23. A decoupling means 24 is provided on the inner wall of bearing spring 11 for decoupling small amplitudes. The latter is formed as a compressible material layer, such as of a closed-pore foamed material.

In all previously described exemplary embodiments, a bearing spring 11 is used which is of a composite fiber material, wherein the matrix material of the composite fiber material is a thermoplastic material having high thermal stability, which can be processed by means of deep drawing. High heat resistance of the drive unit mount of ≧130° C. is thus achieved. Moreover, bearing spring 11 used results in only very little settling under initial load, wherein the small linear free stroke is not substantially reduced during the entire useful life of drive unit mount 10. Drive unit mount 10 has the further advantage of having only slight dynamic hardening.

### LIST OF REFERENCE NUMERALS

10 Drive unit mount

11 Bearing spring

12 Mounting bolt

13 Fixing bolts

14 Corrugated structure

15 Working chamber

16 Edge

17 Coating

18 Bottom plate

19 Nozzle channel

20 Balancing chamber

21 Intermediate plate

22 Balancing membrane

23 Damping channel

24 Decoupling means

1-17. (canceled)

18. A damping drive unit mount, comprising:
a bearing spring defining a working chamber filled with a working medium, said bearing spring formed from a composite fiber material having a matrix material being a thermoplastic material having high thermal stability, and can be processed by means of deep drawing.

19. The dampening drive unit mount according to claim 18, wherein said matrix material is polyphenylene sulfide (PPS).

20. The dampening drive unit mount according to claim 18, wherein said composite fiber material has a material selected from the group consisting of glass fibers, carbon fibers and aramide fibers, used as reinforcing fibers.

21. The dampening drive unit mount according to claim 18, wherein said bearing spring has a layered structure of fibers in a form of at least one of a fabric and a unidirectional fiber layer.

22. The dampening drive unit mount according to claim 21, wherein said layered structure is formed as one of a single layer structure and as a multi-layer structure.

23. The dampening drive unit mount according to claim 18, wherein said bearing spring has a corrugated structure formed into it.

24. The dampening drive unit mount according to claim 18, further comprising an intermediate plate and said bearing spring is fixed on said intermediate plate.

25. The dampening drive unit mount according to claim 18, further comprising a mounting bolt cast into said matrix material of said bearing spring.

26. The dampening drive unit mount according to claim 18, wherein the dampening drive unit mount is formed as a pneumatically damping mount, and said working chamber is filled with a gas.

27. The dampening drive unit mount according to claim 25, further comprising a nozzle channel and said working chamber communicates with the environment via said nozzle channel.

28. The dampening drive unit mount according to claim 25, wherein said bearing spring has an inner wall with a coating reducing a volume of said working chamber.

29. The dampening drive unit mount according to claim 28, wherein said coating is of a closed-pore foamed material having high heat resistance.

30. The dampening drive unit mount according to claim 18, wherein the dampening drive unit mount is a hydraulically damping mount, and said working chamber is filled with a hydraulic liquid.

31. The dampening drive unit mount according to claim 29, further comprising:
a dampening channel; and
a balancing chamber, said working chamber communicates with said balancing chamber via said damping channel.

32. The dampening drive unit mount according to claim 31, wherein said balancing chamber is defined by a balancing membrane of an elastic material.

33. The dampening drive unit mount according to claim 18, further comprising a decoupling means for decoupling small amplitudes and disposed in said working chamber.

34. The dampening drive unit mount according to claim 33, wherein said decoupling means is formed from a compressible material layer of a closed-pore foamed material applied to an inner wall of said bearing spring.

35. The dampening drive unit mount according to claim 18, wherein said bearing spring is fixed on a bottom of the dampening drive unit mount.

36. The dampening drive unit mount according to claim 18, wherein the dampening drive unit mount is an engine mount for a motor vehicle.

37. The dampening drive unit mount according to claim 26, wherein said gas is air.

38. The dampening drive unit mount according to claim 25, further comprising:
a nozzle channel; and
a balancing chamber, said working chamber communicates with said balancing chamber via said nozzle channel.
